(19) United States
(12) Patent Application Publication
(10) Pub. No.: US 2012/0098885 A1
(43) Pub. Date: Apr. 26, 2012

(54) SEAL TAPE FOR INK JET RECORDING HEAD, AND INK JET RECORDING HEAD

(75) Inventors: Kouji Harada, Kawasaki-shi (JP); Tadayoshi Inamoto, Hachioji-shi (JP)

(73) Assignee: CANON KABUSHIKI KAISHA, Tokyo (JP)

(21) Appl. No.: 13/228,235

(22) Filed: Sep. 8, 2011

(30) Foreign Application Priority Data
Oct. 22, 2010 (JP) 2010-237396

(51) Int. Cl. B41J 2/165

(52) U.S. Cl. 347/29

(57) ABSTRACT

A seal tape for protecting an ejection orifice face in which an ejection orifice for ejecting ink is formed, comprising a substrate and an adhesive layer,
wherein the adhesive layer comprises a crosslinked resin mixture comprising at least:
(a) a polydimethylsiloxane resin of the formula (1) in content of from 60 to 90% by mass,

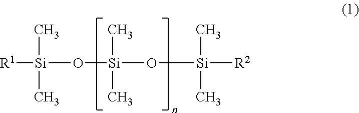

wherein R¹ and R² each independently represent an alkyl radical or hydroxyl radical, and n represents an integer, and
(b) an MQ resin composed of (R)₃SiO_{1/2} units [M-units] wherein three substituents R bonded to Si each independently represent an alkyl or hydroxyl radical and SiO_{4/2} units [Q-units] in a content of 10 to 40% by mass, and
wherein a probe tack measured value of the seal tape is from 0.3 to 1.6 N.

### BACKGROUND OF THE INVENTION

1. Field of the Invention

The present invention relates to a seal tape for an ink jet recording head, and an ink jet recording head having the tape.

2. Description of the Related Art

An ejection orifice of an ink jet recording head is made open in the atmospheric air in order to eject an ink when the head is used. When the head is not used, the ejection orifice is subjected to capping or the like so as to be protected, thereby preventing the ejection orifice from being clogged by the evaporation of a solvent in the ink, and from being damaged by the contact of an alien substance with the ejection orifice.

In order to protect the ejection orifice when the head is not used, in particular, when the head is in the process of physical distribution, the following method is also known besides the capping: a method of applying a seal tape having adhesiveness to the ejection orifice face to protect the ink ejection orifice.

The seal tape, which is applied to the ink jet recording head, is kept over a long term while in contact with an ink held inside the ejection orifice through its adhesive layer between the tape and the ink; thus, the adhesive layer of the seal tape is required to have the following performances. 1) Peeling properties: even when the adhesive layer is kept over a long term while in contact with the ink, there is not caused a phenomenon that the adhesive layer is peeled off from the ejection orifice face so as to cause the ink exudation. 2) Elution-into-ink resistance: even when the adhesive layer is kept over a long term while in contact with the ink, there is not caused a phenomenon that the adhesive layer elutes into the ink to give an effect onto physical properties of the ink. 3) High cohesive force: even when the adhesive layer is kept over a long term while in contact with the ink, the adhesive agent does not undergo cohesive failure in peeling off the seal tape so that the adhesive agent does not remain on the ejection orifice face. 4).Appropriate peel strength: even when the adhesive layer is kept over a long term while in contact with the ink, the adhesive layer does not deform or break the ejection orifice not to give any damages thereto in peeling off the seal tape.

As a seal tape satisfying these performances, Japanese Patent No. 3334899 discloses a seal tape having an adhesive layer containing a silicone resin as an adhesive agent.

The silicone adhesive agent disclosed therein is a condensate containing, as main components, a methylsilicone rubber having silanol radicals at its terminals, and a ladder-form methylsilicone resin having terminals blocked with methylsilicone radicals. More specifically, the adhesive agent is an agent obtained by adding an alkoxysilane as a crosslinking agent to these silicone compounds, and condensing the resultant with a metal compound catalyst containing a metal such as Sn or Pt, or an organic peroxide catalyst such as benzoyl peroxide.

In order to obtain the properties 1) to 4), in particular, 2) elution-into-ink resistance (the above-mentioned Patent Literature describes this resistance as non-bleeding property), the completion of the crosslinking reaction is attained by drying the mixed components at 130° C. for 10 minutes (and simultaneously causing crosslinking), and subsequently aging the resultant at 50° C. for one week.

Lately, crosslinking by irradiation with an electron beam (hereinafter referred to as electron beam crosslinking) has been known as a manner for crosslinking a silicone adhesive agent. The electron beam crosslinking is a manner of irradiating a silicone adhesive agent with an electron beam without using any crosslinking agent or catalyst to crosslink the silicone adhesive agent.

An adhesive tape for roll-replacement in which a silicone adhesive agent subjected to electron beam crosslinking is used is disclosed in Japanese Patent Application Laid-Open No. 2009-114445. This adhesive tape for roll-replacement is designed in order to give a high initial adhesive power to a silicone surface of a web material in a short contact time, and keep a high cohesive force even in a high-temperature environment during operation.

### SUMMARY OF THE INVENTION

However, in the case of using, for example, a substrate poor in heat resistance, such as a polyethylene terephthalate (PET) substrate, as a substrate for supporting an adhesive layer in the seal tape in Japanese Patent No. 3334899, the following is conceived: the substrate is exposed to a temperature higher than 100° C. in the coating and drying step, whereby the seal tape may frequently wrinkle or wave after such step.

When a coating solution containing raw materials, a crosslinking agent, and a catalyst is allowed to stand still in the state that the solution is formulated, a crosslinking reaction may advance with time, so that the solution may increase its viscosity. Thus, a coating failure may be caused. In other words, the coating solution is not easily stocked over a long period of time. From such a viewpoint, in order to make the productivity of seal tapes higher, it has been desired to make the temperature for the crosslinking step lower, and improve the pot life of the coating solution.

The silicone adhesive agent disclosed in Japanese Patent Application Laid-Open No. 2009-114445 does not need to be heated for being crosslinked; thus, the seal tape therein is heated only to a temperature at which a solvent of the coating solution for the adhesive agent can be dried (about 100° C. or lower), so that the frequency of the generation of the wrinkle or wave phenomenon is decreased. Moreover, the adhesive agent neither requires any crosslinking agent nor any catalyst; thus, it is unnecessary to consider the pot life of the coating solution.

However, when the adhesive tape disclosed in Japanese Patent Application Laid-Open No. 2009-114445 is used as a seal tape for an ink jet recording head, it is assumed that the seal tape may not sufficiently have, out of the above-mentioned performances required for ink jet recording head seal tapes, 3) high cohesive force nor 4) appropriate peel strength.

Specifically, in connection with 3) high cohesive force, the seal tape in Japanese Patent Application Laid-Open No. 2009-114445 contains a MQ resin, which is a relatively low-molecular weight component, in a high proportion of 45% or more by mass in order to gain an initial adhesive power, so that the cohesive force of the tape tends to lower in contrast to the adhesiveness thereof. When this seal tape is used as an ordinary adhesive tape, it is not critical that the adhesive agent therein unfavorably remains in a very small amount. However, in a case where the seal tape is used as a seal tape for protecting the ejection orifices of an ink jet recording head, a printing failure may be caused even when the adhesive agent therein remains in an amount corresponding to the thickness of about 10 to 20 μm. For this reason, it is required that the adhesive layer has a higher cohesive force so that the adhesive agent therein is restrained from remaining even in a very small amount.

In connection with 4) appropriate peel strength, the seal tape in Japanese Patent Application Laid-Open 2009-114445 has a high adhesiveness from the initial stage, and after the seal tape is in a physical distribution process over a long period of time, the adhesive layer adapted to the ejection orifice face exhibits, when peeled off, a strong adhesive power to cause the ejection orifice face to be deformed or damaged, or undergo some damage.

Even when it is supposed that the adhesive layer is so designed simply as to control the initial adhesive power thereof to be lower, the adhesive layer is required to be strictly controlled in order that the seal tape having the adhesive layer with the initial adhesive power can keep a sufficient adhesiveness over the period from a time just after the seal tape is applied to an ejection orifice face to a time when its physical distribution process is ended.

As described above, any conventional seal tape is a tape in which the performances required for seal tapes are partially improved. An object of the invention is to provide a seal tape for an ink jet recording head for improving at least one of the performances 1) to 4), and an ink jet recording head having this seal tape. The seal tape of the invention is a seal tape for protecting an ejection orifice face (ejection device substrate surface) in which an ejection orifice for ejecting an ink is formed, including a substrate and an adhesive layer, wherein the adhesive layer includes a crosslinked resin mixture including at least (a) a polydimethylsiloxane resin represented by the following formula (1) in a content of from 60 to 90% by mass,

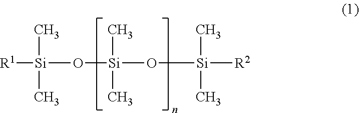

where R¹ and R² each independently represent an alkyl radical, or a hydroxyl radical, and n represents an integer, and (b) an MQ resin composed of (R)₃SiO_{1/2} units [M-units] where three substituents R bonded to Si each independently represent an alkyl radical or a hydroxyl radical and SiO_{4/2} units [Q-units] in a content of from 10 to 40% by mass, wherein the probe tack measured value of the seal tape, the value being a value showing the intensity of the adhesive power of the tape just after the tape is applied to the ejection orifice face, is from 0.3 to 1.6 N.

The invention also relates to an ink jet recording head having an ejection orifice face in which an ejection orifice for ejecting an ink is formed, to which recording head a seal tape including a substrate and an adhesive layer to seal the ejection orifice face is peelably attached, wherein the adhesive layer includes a crosslinked resin mixture including at least (a) a polydimethylsiloxane resin represented by the following formula (1) in a content of from 60 to 90% by mass,

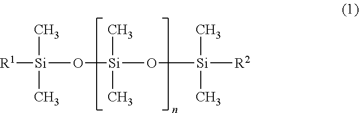

where R¹ and R² each independently represent an alkyl radical, or a hydroxyl radical and n represents an integer, and (b) an MQ resin composed of (R)₃SiO_{1/2} units [M-units] where three substituents R bonded to Si each independently represent an alkyl radical or a hydroxyl radical and SiO_{4/2} units [Q-units] in a content of from 10 to 40% by mass, wherein the probe tack measured value of the seal tape, the value being a value showing the intensity of the adhesive power of the tape just after the tape is applied to the ejection orifice face, is from 0.3 to 1.6 N.

Further features of the present invention will become apparent from the following description of exemplary embodiments with reference to the attached drawings.

### BRIEF DESCRIPTION OF THE DRAWINGS

FIG. 1 is a sectional view illustrating an embodiment of the ink jet recording head seal tape of the invention.

FIG. 2 is a perspective view illustrating an embodiment of the ink jet recording head of the invention.

### DESCRIPTION OF THE EMBODIMENTS

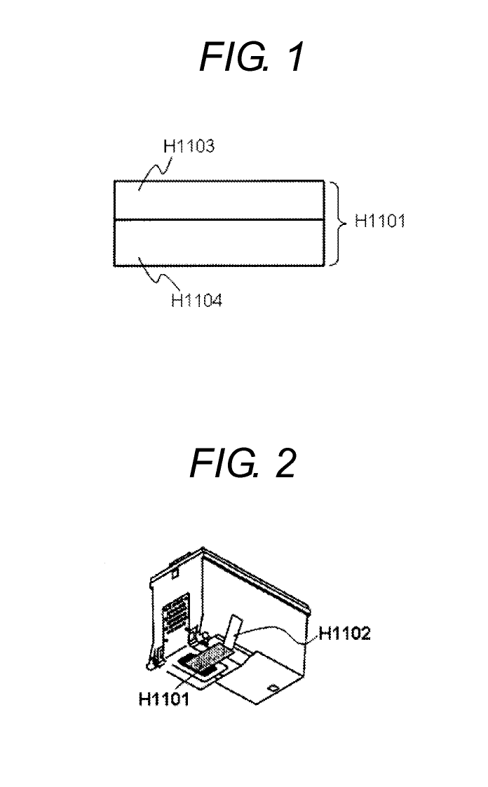

Preferred embodiments of the present invention will now be described in detail in accordance with the accompanying drawings. FIG. 1 is a view illustrating the structure of a seal tape for an ink jet recording head according to the present invention. This seal tape, which is a tape H1101, is composed of an adhesive layer H1104 which is to be attached to an ejection orifice face when the seal tape H1101 is applied to the head, and a substrate H1103 for supporting the adhesive layer.

FIG. 2 is a view illustrating an example of an ink jet recording head to which the invention is applied. This ink jet recording head is of an ink-tank-integrated type, and an ink is filled into its ink tank. To its ejection orifice face for ejecting the ink is peelably attached the seal tape H1101, for protecting the ejection orifice face, through the adhesive layer H1104.

Furthermore, as illustrated in FIG. 2, a tag H1102 for easy peeling of the seal tape H1101 may be provided to the seal tape H1101. In a physical distribution process of the ink jet recording head, the seal tape H1101 is used to seal the ejection orifice, thereby protecting the ejection orifice and further preventing ink leaking from the ejection orifice due to a temperature or pressure fluctuation generated in the physical distribution.

The ink jet recording head seal tape of the invention may be applied to an ink jet recording head of an ink-tank-separated type.

Next, a detailed description is made about each of the members that constitute the seal tape for an ink jet recording head of the invention.

<Substrate>

Examples of the substrate used in the seal tape of the invention include, films each being composed of, as a main component, for example, polyethylene terephthalate (PET), polyethylene naphthalate (PEN), or polybutylene terephthalate (PBT). From these films, any film may be selected and used. It is particularly desired to use a film obtained by biaxially stretching any one of these films.

A colored layer may be laid onto the substrate if necessary. The method for introducing the colored layer is not particularly limited as far as the method is a known method.

Furthermore, a known bondability improving method may be applied to the substrate in order to improve the bondability of the substrate onto the adhesive layer as far as the advantageous effects of the invention are not damaged. The method may be, for example, that employing surface treatment, or that of laying a bonding layer between the substrate and the adhesive layer. Specific examples of the surface treatment include corona treatment, flame treatment, and plasma treatment. An easy bonding layer to be laminated is, for example, a layer made of a resin having a high polarity, such as a polyester resin or a polyurethane resin. Commercially available products of the former and latter resins are typically “VYLONAL (trade name)” manufactured by Toyobo Co., Ltd., and “HYDRAN (trade name)” manufactured by Dainippon Ink & Chemicals, Inc., respectively.

The thickness of the substrate is preferably 20 μm or more from the viewpoint of working performance in the production of the seal tape, and is preferably 80 μm or less from the viewpoint of the restraint of a load onto a blade when the substrate is cut.

<Adhesive Layer>

The adhesive layer used in the invention contains a polydimethylsiloxane resin and an MQ resin, which may each be of a silicone type, and these resins are specifically resins described in the following. A non-crosslinked silicone resin containing the polydimethylsiloxane resin and the MQ resin in a predetermined ratio is irradiated with an electron beam to be crosslinked. It is possible for the adhesive layer to use a non-crosslinked silicone resin containing a different resin and a bondability improver that will be described later.

(a) a polydimethylsiloxane resin represented by the following formula (1):

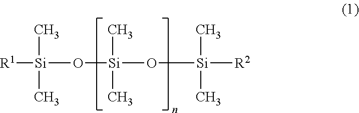

where R¹ and R² each independently represent an alkyl radical, or a hydroxyl radical, and n represents an integer; and

(b) an MQ resin composed of (R)₃SiO_{1/2} units [M-units] where three substituents R bonded to Si each independently represent an alkyl radical or a hydroxyl radical and SiO_{4/2} units [Q-units].

Hereinafter, a description is made about each of the components incorporated into the adhesive layer.

Polydimethylsiloxane Resin:

The polydimethylsiloxane resin (a) represented by the formula (1) in the non-crosslinked silicone resin may be, for example, a resin commercially available as a linear silicone oil.

It is preferred to use, among linear silicone oils, dimethylsilicone oil, which is unreactive and is a resin wherein the substituents R¹ and R² are each a methyl radical, from the viewpoint of storage stability.

The number-average molecular weight (Mn) of the polydimethylsiloxane resin (a) is preferably from 50,000 to 500,000, more preferably from 150,000 to 250,000. When the molecular weight Mn is 50,000 or more, the resin is favorably made better in crosslinkability. When the molecular weight Mn is 500,000 or less, it is supposed in particular that the operating performance for producing the seal tape is declined due to considerably increased viscosity of a coating solution.

The content of the polydimethylsiloxane resin (a) is set into the range of 60 to 90% by mass, preferably 70 to 80% by mass of the total of the non-crosslinked silicone compound. If the content by percentage is less than 60% by mass, the cohesive force of the adhesive layer obtained after the resin is crosslinked may be insufficient. If the content by percentage is more than 90% by mass, the adhesive layer becomes too hard not to gain an initial adhesive power. Thus, the layer may be peeled off.

(MQ Resin)

At least one of the substituents R in the MQ resin (b) used in the invention is preferably a methyl radical. When the substituent is a methyl radical, crosslinkage is generated between the resin (b) and the polydimethylsiloxane resin (a) by the radiation of an electron beam so that the adhesive layer can obtain a higher cohesive force.

The number-average molecular weight (Mn) of the MQ resin (b) used in the non-crosslinked silicone compound is preferably from 1,000 to 2,500 from the viewpoint of the cohesive force.

The content of the MQ resin (b) by percentage is set into the range of 10 to 40% by mass of the total (100%) of the non-crosslinked silicone compound. If the content is less than 10% by mass, the adhesive layer is insufficient in adhesive power so that the layer may not obtain an initial adhesive power. If the content is more than 40% by mass, the adhesive layer is too high in initial adhesive power so that after the ink jet recording head is put into a physical distribution, the layer may damage the front surface of the ejection device substrate. The content is set preferably into the range of 20 to 30% by mass.

Different Resin:

Besides the polydimethylsiloxane resin and the MQ resin, a silicone resin having no polydimethylsiloxane skeleton may be incorporated into the non-crosslinked silicone compound; this optional resin may be of a methylphenyl type, a methyl/hydrogen type, or of various modified types. At this time, the content of the optional silicone resin is preferably set to less than 10% by mass of the non-crosslinked silicone compound.

Specifically, a silicone resin having methylphenyl radicals tends to have low crosslinkability in electron beam crosslinking, and a silicone resin having reactive methyl/hydrogen radicals tends to have low storage stability and the like, so that the resins may produce a bad effect onto the quality of the seal tape or operating performance. Thus, it is most preferred that the non-crosslinked silicone compound used in the invention is made only of the two resins, i.e., (a) polydimethylsiloxane resin and (b) MQ resin.

The non-crosslinked silicone compound may contain a resin having a polyalkylalkenylsiloxane skeleton, which has alkenyl radicals as substituents. At this time, the content of this resin in the non-crosslinked silicone compound is set preferably into the range of 10% by mass or less. This makes,it possible that when an easy bonding layer having a high polarity is laid onto the substrate, the adhesiveness between the adhesive layer and a base film is made better.

A bondability improver may be added to the non-crosslinked silicone compound to make the bondability between the substrate and the adhesive layer strong as far as the advantageous effects of the invention are not damaged. The addition amount thereof is preferably 5% by mass or less of the total of the non-crosslinked silicone compound containing the bondability improver.

The bondability improver may be, for example, a polyfunctional (meth) acrylate compound, a typical example of which is trimethylolpropane trimethacrylate. The bondability improver is crosslinked together with the silicone compound when irradiated with an electron beam. As a result, the bondability between the substrate and the adhesive layer can be made better.

In the invention, the method for forming the adhesive layer may be appropriately selected from adhesive-layer-forming methods known in the field of seal tapes used for ink jet recording heads. However, the method is preferably a method of dissolving or dispersing the non-crosslinked silicone compound into a solvent and optionally adding the bondability improver thereto to prepare a coating solution, applying the coating solution onto the substrate in a known coating method followed by crosslinking treatment to form the adhesive layer. At this time, a film (such as a PET separator film) subjected to peeling treatment may be laminated onto the front surface of the non-crosslinked adhesive layer. By applying an electron beam from the separator film side thereof, the adhesive layer may be crosslinked.

A machine for applying the electron beam, which is used to crosslink the non-crosslinked silicone resin, is preferably a low-energy type electron beam radiating machine (EB radiating machine) since the machine is readily available. The radiation dose of the electron beam from the EB radiating machine is preferably from 100 to 300 kGy (from 10 to 30 Mrad). When the radiation dose of the electron beam is set to 100 kGy or more, the crosslinking reaction of the silicone compound can be further promoted so that the adhesive layer can be further improved in cohesive force. This makes it possible, in particular, that when the seal tape is peeled off after the ink jet recording head is put into a physical distribution, the adhesive agent is restrained from remaining on the front surface of the ejection device substrate. By contrast, when the radiation dose of the electron beam is set to 300 kGy or less, the adhesive agent can be restrained, in particular, from being lowered in initial adhesive power due to an excessive advance of the crosslinking reaction.

When the electron beam is applied onto the silicone resin, the following appears to be caused: for example, in the case where (a) the polydimethylsiloxane resin, (b) and the MQ resin have methyl radicals, hydrogen is abstracted from the methyl radicals, so that between adjacent molecules of the resins from which hydrogen is abstracted a crosslinking reaction is caused. It is therefore unnecessary in the crosslinking method through the electron beam that an additive (such as a peroxide or a crosslinking catalyst) for generating radicals is added to the silicone compound. For this reason, it is unnecessary to consider the pot life after the addition of a crosslinking catalyst and the like in the production of the seal tape. Thus, produced is an advantage that the productivity of the seal tape can be improved since the crosslinking is effectively finished in a short time. Moreover, the incorporation of no additive makes it possible to restrain the following decrease of the cohesive force: a decreased cohesive force associated with a local crosslinking-density-difference that originates from the dispersion of additives; and a decreased cohesive force due to additives that also function as a plasticizer. Such decreases are not caused so that the adhesive layer can gain a high cohesive force.

When the seal tape of the invention, in which the silicone adhesive agent crosslinked through an electron beam is used, is used for an ink jet recording head, there can be eliminated a phenomenon that an additive such as a peroxide or crosslinking catalyst elutes into the ink, or that the additive is bonded or fixed onto the front surface of its ejection device substrate, as described above. Furthermore, when the electron beam is radiated, both of (a) polydimethylsiloxane resin and (b) MQ resin can be involved in the crosslinking reaction so that these resins are linked with each other through bonds. As a result, the adhesive layer can gain a high cohesive force. In short, at the time of peeling off the seal tape after the head is put into a physical distribution, the adhesive agent can be restrained from remaining on the ejection orifice face.

As described above, any seal tape used for an ink jet recording head, the following are required: from the viewpoint of a protection of the ejection orifice face, a restraint of the solidification of an ink through ink-solvent evaporation, and a decrease in damage onto the ejection device substrate due to an increase in the peel strength of the tape after the physical distribution, the adhesiveness of the seal tape is required to be strictly managed, considering adhesive powers from the initial adhesive power to the adhesive power after the physical distribution. The wording “initial adhesive power” referred to herein denotes the intensity of the adhesive power of the seal tape with respect to an ejection orifice face just after the tape is applied to the face. The inventors have investigated intensively to decide a preferred range of the “initial adhesive power” for expressing the above-mentioned performances required for the seal tape using the silicone adhesive tape.

The initial adhesive power may be measured with a probe tack tester (trade name: TE-6001, manufactured by Tester Sangyo Co., Ltd.). The method for the measurement is according to ASTM D2979, and the used probe is a probe having a cross section having a diameter of 5 mm9, and having a seal-tape-contacting region coated with polytetrafluoroethylene (PTFE). Conditions for the measurement are as follows: contacting load: 19.6 N (2 kgf); contacting speed: 10 mm/sec.; contacting period: 1.0 sec.; and peeling speed: 10 mm/sec.

The initial adhesive power of the seal tape of the invention is from 0.3 to 1.6 N, preferably from 0.6 to 1.2 N in the probe tack measured value. Specifically, if the value is less than 0.3 N, in a physical distribution process, the seal tape may be peeled off from the head or the ink may exude. If the value is more than 1.6 N, after the physical distribution, the adhesiveness increases excessively so that the tape may damage the ejection orifice face.

As described above, the seal tape of the invention includes an adhesive layer yielded by crosslinking through an electron beam, a silicone compound containing at least 60 to 90% by mass of (a) polydimethylsiloxane resin and 10 to 40% by mass of (b) MQ resin. Thus, even when an additive is not added thereto, the adhesive agent can be restrained from eluting into the ink. Moreover, both of (a) polydimethylsiloxane resin and (b) MQ resin are involved in the crosslinking reaction so that the adhesive layer can gain a high cohesive force. Thus, when the tape is peeled off from the head, the adhesive agent can be restrained from remaining thereon.

Additionally, the initial adhesive power of the seal tape of the invention is from 0.3 to 1.6 N in the probe tack measured value. This makes the following possible: the tape has an initial adhesive power sufficient not to cause the exudation of the ink in a physical distribution; and the seal tape is peeled off at a low peel strength without damaging its ejection device substrate even after the distribution. As a result, the reliability of the ink jet recording head can be improved.

The thickness of the adhesive layer is preferably 25 μm or more from the viewpoint of the property of following irregularities of a surface to which the layer is to be applied, and is preferably 60 μm or less from the viewpoint of a restraint of the adhesion onto a blade when the tape is cut.

### EXAMPLES

Hereinafter, examples and comparative examples of the invention will be described.

Examples 1 to 9, and Comparative Examples 1 to 4: Ink jet recording head seal tapes of Examples 1 to 9 and Comparative Examples 1 to 4 were produced through a producing process described below.

In Table 1 are shown compositions of non-crosslinked silicone resins corresponding to each of Examples 1 to 9 and Comparative Examples 1 to 4 (the content of each material is the proportion (%) by mass of the material with respect to the total (100%) mass of the silicone resins).

In each of Examples 1 to 9 and Comparative Examples 1 to 4, used was a non-crosslinked silicone compound composed of a polydimethylsiloxane resin 1, 2, 3 or 4, and an MQ resin 1 or 2 described below.

Used Materials

Polydimethylsiloxane resin 1 having a structure represented by the formula (1): resin having a number-average molecular weight Mn of 200,000, and having methyl radicals as R¹ and R² in the formula (1).

Polydimethylsiloxane resin 2 having a structure represented by the formula (1): resin having a number-average molecular weight Mn of 150,000, and having methyl radicals as R¹ and R² in the formula (1).

Polydimethylsiloxane resin 3 having a structure represented by the formula (1): resin having a number-average molecular weight Mn of 100,000, and having methyl radicals as R¹ and R² in the formula (1).

Polydimethylsiloxane resin 4 having a structure represented by the formula (1): resin having a number-average molecular weight Mn of 300,000, and having a methyl radical as R¹ and a hydroxyl radical as R² in the formula (1).

MQ resin 1 having (R)₃SiO_{1/2} units [M-units] and SiO_{4/2} units [Q-units]: resin having a number-average molecular weight Mn of 1,000.

MQ resin 2 having (R)₃SiO_{1/2} units [M-units] and SiO_{4/2} units [Q-units]: resin having a number-average molecular weight Mn of 2,000.

Each of the number-average molecular weights Mn was measured by GPC (gel permeation chromatography), and is a value in terms of polystyrene molecular weight.

Seal Tape Producing Process

In each of Examples 1 to 9 and Comparative Examples 1 to 3, the non-crosslinked silicone compound described in Table 1 was weighed to set the proportion thereof to 23% by mass with respect to toluene, and then the compound was put, together with toluene, into a stirrer with a vacuum degassing device. These components were stirred at room temperature (25° C.) under the atmospheric pressure (1.0 x 10⁵ Pa) for 15 hours to dissolve the compound into toluene. While the vacuum degassing device was driven, the resultant solution was further stirred under a vacuum having a gauge pressure of −1.0×10⁵ Pa (−750 mmHg) for 20 minutes to degas the solution.

Next, the silicone compound solution after the degassing was supplied to a roll coater, and applied onto a substrate having a thickness of 38 μm and made only of PET to give a thickness of 45 μm after the resultant coat would be dried. Subsequently, the product was introduced into an oven, and then dried at 80° C. to laminate a non-crosslinked adhesive layer onto the substrate.

Furthermore, while a PET separator film subjected to peeling treatment was put onto the front surface of the non-crosslinked adhesive layer, the film was pressed under a pressure of 3.0×10⁵ Pa (30 N/cm²) by a compression roller. In this way, the film was continuously laminated onto the front surface. Furthermore, the resultant laminated film was continuously introduced into an electron beam radiating machine. An electron beam was applied onto the film from the separator film side thereof at an energy of 200 KV and 180 kGy (18 Mrad) to crosslink the adhesive layer. The resultant seal tape, which had the crosslinked adhesive layer, was wound into a roll from.

In Comparative Example 4, a seal tape was produced by performing the same process as in the other examples except that the energy for the electron beam radiation was changed to an energy of 200 KV and 80 kGy (8 Mrad).

The probe tack measured value of each of the seal tapes produced as described above is shown as the initial adhesive power thereof in Table 1. In the measurement, a probe tack tester (trade name: TE-6001, manufactured by Tester Sangyo Co., Ltd.) was used. The method for the measurement was according to ASTM D2979, and the used probe was a probe having a cross section having a diameter of 5 mmφ, and having a seal-tape-contacting region coated with PTFE. Conditions for the measurement were set to as follows: contacting load: 19.6 N (2 kgf); contacting speed: 10 mm/sec.; contacting period: 1.0 sec.; and peeling speed: 10 mm/sec.

TABLE 1
Non-crosslinked silicone compound composition and probe
tack measured values

| | | | | | Initial |
|---|---|---|---|---|---|
| | Non-crosslinked silicone compound composition | | | | adhe- |
| | (a) Polydimethylsiloxane | | | | sive |
| | resin | | (b) MQ resin | | power |
| | | Content | | Content | (probe |
| | | (% by | | (% by | tack) |
| | Compound | mass) | Compound | mass) | (N) |
| Example 1 | Polydimethylsiloxane | 60 | MQ resin | 40 | 1.5 |
| | resin 1 | | 1 | | |
| Example 2 | Polydimethylsiloxane | 60 | MQ resin | 40 | 1.6 |
| | resin 3 | | 1 | | |
| Example 3 | Polydimethylsiloxane | 60 | MQ resin | 40 | 1.3 |
| | resin 4 | | 1 | | |
| Example 4 | Polydimethylsiloxane | 60 | MQ resin | 40 | 1.5 |
| | resin 1 | | 2 | | |
| Example 5 | Polydimethylsiloxane | 90 | MQ resin | 10 | 0.3 |
| | resin 1 | | 1 | | |
| Example 6 | Polydimethylsiloxane | 65 | MQ resin | 35 | 1.3 |
| | resin 2 | | 2 | | |
| Example 7 | Polydimethylsiloxane | 80 | MQ resin | 20 | 0.6 |
| | resin 1 | | 1 | | |
| Example 8 | Polydimethylsiloxane | 70 | MQ resin | 30 | 1.2 |
| | resin 1 | | 1 | | |
| Example 9 | Polydimethylsiloxane | 75 | MQ resin | 25 | 1 |
| | resin 2 | | 1 | | |
| Comparative | Polydimethylsiloxane | 95 | MQ resin | 5 | 0.2 |
| Example 1 | resin 1 | | 1 | | |
| Comparative | Polydimethylsiloxane | 55 | MQ resin | 45 | 2.1 |
| Example 2 | resin 1 | | 1 | | |
| Comparative | Polydimethylsiloxane | 45 | MQ resin | 55 | 2.7 |
| Example 3 | resin 2 | | 1 | | |
| Comparative | Polydimethylsiloxane | 80 | MQ resin | 20 | 1.7 |
| Example 4 | resin 1 | | 1 | | |

Three methods for evaluating the seal tapes of the above-mentioned examples and comparative examples are described below.

<Evaluating Method 1: Sealing Performance Evaluation>

The seal tape of each of the examples and comparative examples was cut into a desired size, and the separator film was peeled off therefrom. The seal tape piece was applied onto an ejection orifice face of the ink jet recording head (trade name: FINE Cartridge BC-311, manufactured by Canon Inc.) as illustrated in FIG. 2 in which no seal tape was applied thereto.

The ink jet recording head is designed to eject ink droplets having a volume of at least 2 pL, and the diameter of the ejection orifice is 10 μm. This ink jet recording head, in which the ejection orifice was sealed, was packed. While this packed state was kept, the head was subjected to an H/C test (in which a cycle of changing the environmental temperature as follows was repeated 10 times in total: room temperature (25° C.)/60° C./room temperature/−30° C./room temperature, each of these temperatures being kept for 2 hours). After the end of the test, the ink jet recording head was unpacked, and then ejection orifice face of the head was visually observed with a stereoscopic microscope to evaluate whether or not the seal tape was peeled off, and whether or not the ink exuded.

The evaluation result was as follows: OK: the ink did not exude, and the seal tape was not peeled off. or
NG: at least one of the exudation of the ink and the peeling off of the seal tape was caused.

<Evaluating Method 2: Evaluation of the Peeling Properties After Storage (Observation of the Maximum Peel Strength and the External Appearance of the Ejection Device Substrate Front Surface>

In the same manner as in the evaluating method 1, seal tapes of each of the examples that were each cut into a desired size were each applied to the ink jet recording head in which no seal tape was applied, and then it was packed. Thereafter, the seal tapes were stored for 2 months while heated to 60° C. From the storage state, the packed ink jet recording heads were taken out, and then unpacked. The seal tapes were each peeled off therefrom into a 90-degree direction at a speed in the speed range of 5 to 300 mm/sec. The peel strength thereof was measured with a peeling tester. The peel strength is varied in accordance with the peeling speed; thus, the maximum value out of the peel strengths measured at respective peeling speeds of 5, 30, 165 and 300 mm/sec, was defined as the maximum peel strength.

As this peel strength is lower, a damage onto the ejection orifice face can be further decreased, which is more preferred. The seal-tape-peeled ejection orifice face was visually observed with a metal microscope to evaluate whether or not the ejection orifice face was cracked.

The evaluation result was as follows:

OK: the ejection orifice face was not cracked, or

NG: the ejection orifice face was cracked.

<Evaluating Method 3: Printed Image Evaluation After Storage>

In the same manner as in the evaluating method 2, a seal tape of each of the examples was applied to the ink jet recording head in which no seal tape was applied, and then it was packed. Thereafter, the seal tape was stored for 2 months while heated to 60° C. From the storage state, the packed ink jet recording head was taken out, and then unpacked. The seal tape was then peeled off therefrom, and the head was installed to an ink jet printer (trade name: MP 480, manufactured by Canon Inc.). The printer was used to print images.

An evaluation was made as to whether or not the ink was not ejected so that an image defect was generated.

The evaluation result was as follows:

OK: no image defect was generated, or

NG: one or more image defects were generated (i.e., ejection failure was caused).

The evaluating methods 1 to 3 were used to evaluate the examples and the comparative examples. The results are shown in Table 2.

TABLE 2
Evaluation results

| | | After storage | | |
|---|---|---|---|---|
| | | | Evaluation | |
| | | | of external | |
| | | | appearance | |
| | | Maximum | of ejection | |
| | Sealing | peel | device | Printed |
| | performance | strength | substrate | image |
| | evaluation | (N/m) | surface | evaluation |
| Example 1 | OK | 150 | OK | OK |
| Example 2 | OK | 162 | OK | OK |
| Example 3 | OK | 132 | OK | OK |
| Example 4 | OK | 155 | OK | OK |
| Example 5 | OK | 68 | OK | OK |
| Example 6 | OK | 134 | OK | OK |
| Example 7 | OK | 86 | OK | OK |
| Example 8 | OK | 126 | OK | OK |
| Example 9 | OK | 105 | OK | OK |
| Comparative | NG | Measurement was unable to be made | | |
| Example 1 | | because of ink-exudation. | | |
| Comparative | OK | 238 | OK | NG |
| Example 2 | | | | |
| Comparative | OK | 275 | NG | No image |
| Example 3 | | | | was printed |
| | | | | because of |
| | | | | crack- |
| | | | | generation. |
| Comparative | OK | 184 | OK | NG |
| Example 4 | | | | |

In the sealing performance evaluation, in Examples 1 to 9, and Comparative Examples 2 to 4, no ink exuded and no seal tape was peeled off. However, in Comparative Example 1, the ink exuded, and a nearly half region of the bonded region of the seal tape was peeled off. When the tape was peeled off and the ejection orifice face was observed, a precipitation that appeared to be based on the evaporation of a solvent in the ink and to originate from the ink was observed in most of the head including the ejection orifice.

In the evaluation of the peeling properties after the storage, in Examples 1 to 9, such low peeling properties that the maximum peel strength was less than 200 N/m were attained. By contrast, in Comparative Examples 2 and 3, the maximum peel strength was far larger than 200 N/m and, in particular, in Comparative Example 3, the observation result of the ejection orifice face with the metal microscope demonstrated that the ejection device substrate was cracked.

In the printed image evaluation after the storage, no ejection failure of the ink was caused so that good images were printed in Examples 1 to 9. By contrast, in Comparative Example 3, the head was cracked so that no image was able to be printed. In Comparative Examples 2 and 4, image defect portions due to ejection failure were slightly observed. Regions near the ink ejection orifice corresponding to the image defect portions were checked. As a result, small adhesive agent remnants were observed.

As described above, it was demonstrated that the ink jet recording head seal tape of the invention has an adhesive power sufficient to seal an ejection orifice, for ejecting an ink, in an ink jet recording head, and further the seal tape relieves a damage onto the ejection orifice face of the head having the tape when the tape is peeled off from the head after physical distribution process. It was also demonstrated that the seal tape does not give effect onto the printing quality of the ink jet recording head.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-237396, filed Oct. 22, 2010, which is hereby incorporated by reference herein in its entirety.

What is claimed is:

1. A seal tape for protecting an ejection orifice face (ejection device substrate surface) in which an ejection orifice for ejecting an ink is formed, comprising a substrate and an adhesive layer,
wherein the adhesive layer comprises a crosslinked resin mixture comprising at least:
(a) a polydimethylsiloxane resin represented by the following formula (1) in a content of from 60 to 90% by mass, 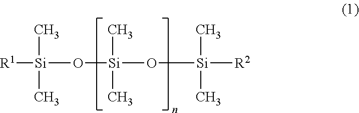
where R¹ and R² each independently represent an alkyl radical, or a hydroxyl radical, and n represents an integer, and
(b) an MQ resin composed of (R)₃SiO_{1/2} units [M-units] where three substituents R bonded to Si each independently represent an alkyl radical or a hydroxyl radical and SiO_{1/2} units [Q-units] in a content of from 10 to 40% by mass, and
wherein a probe tack measured value of the seal tape, the value being a value showing the intensity of the adhesive power of the tape just after the tape is applied to the ejection orifice face, is from 0.3 to 1.6 N.

2. An ink jet recording head having an ejection orifice face in which an ejection orifice for ejecting an ink is formed, to which recording head a seal tape comprising a substrate and an adhesive layer to seal the ejection orifice face is peelably attached,
wherein the adhesive layer comprises a crosslinked resin mixture comprising at least:
(a) a polydimethylsiloxane resin represented by the following formula (1) in a content of from 60 to 90% by mass, 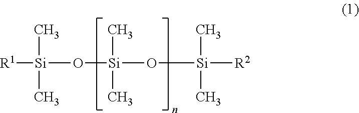
where R¹ and R² each independently represent an alkyl radical, or a hydroxyl radical, and n represents an integer,
(b) an MQ resin composed of (R)₃SiO_{1/2} units [M-units] where three substituents R bonded to Si each independently represent an alkyl radical or a hydroxyl radical, and SiO_{4/2} units [Q-units] in a content of from 10 to 40% by mass, and
wherein a probe tack measured value of the seal tape, the value being a value showing the intensity of the adhesive power of the tape just after the tape is applied to the ejection orifice face, is from 0.3 to 1.6 N.

3. The seal tape according to claim 1, wherein the substrate has a thickness of 20 to 80 μm.

4. The seal tape according to claim 1, wherein the polydimethylsiloxane resin has a number-average molecular weight (Mn) of 50,000 to 500,000.

5. The seal tape according to claim 1, wherein the MQ resin has a number-average molecular weight (Mn) of 1,000 to 2,500.
